(19) United States
(12) Patent Application Publication
(10) Pub. No.: US 2014/0024458 A1
(43) Pub. Date: Jan. 23, 2014

(54) Multi-player Interactive Electronic Dream-matching Game

(71) Applicant: Jeff Greenfield, (US)

(72) Inventor: Jeff Greenfield, (US)

(21) Appl. No.: 13/555,440

(22) Filed: Jul. 23, 2012

(51) Int. Cl. A63F 13/00

(52) U.S. Cl. CPC A63F 13/00
USPC 463/42; 463/1

(57) ABSTRACT

A computer based method for playing an online game via an electronic device includes inputting by a player a summary of a dream. The dream summary is forwarded from the electronic device to a processor, stored in a data storage medium, and then compared to dream summaries of other players as well as to dream features and characteristics stored permanently on the database, based on a dream coding scale. A list of matching data based on comparing the dream summaries of the players is then generated which indicates features of each player's dreams that are common to the participating players and/or the data stored in the database. A player is provided awards in the game based on matches between features of his dreams to those of other players or data, such as actual events that occur after input of the dream summary, stored in the database.

### BACKGROUND OF THE INVENTION

The present invention relates generally to an interactive electronic game and more specifically, is directed to a multi-player interactive, electronic dream-matching game.

Dreams have been a subject of study and analysis for centuries in order to find meaning or sense in the images created by the brain during certain states of sleep. Dreams have even been interpreted as foreseeing or predicting events, including for example the death of a friend or loved one, natural disasters, or even just ordinary events in an individual's life that later trigger a feeling of “déjà vu”. People often maintain “dream journals” to track their dreams as a hobby or as part of analysis to address personal issues. Analysis of sleep patterns and periods of dreaming have been used to treat insomnia and other health issues. A more informal sharing of one's dreams to friends or family is also common, in particular in the mornings after waking and upon remembering especially colorful or disturbing dreams and images.

Over the years, there are been numerous devices and methods developed to record, interpret, and/or analyze dreams. U.S. Pat. No. 6,575,895 describes a programmable apparatus for analyzing dreams, which assists the user in recording his or her dreams. The device includes a microcontroller for receiving input that defines the user's sleep period, calculating the time, and playing an alert for each REM event predicted to occur during the user's sleep period. The strength of each alert may be user-adjusted, such that it is sufficient to wake the user during a REM event, but not during non-REM sleep. The dream analyzer further incorporates a voice activated recording device to allow the user to record a description of his or her dream upon awaking from a REM event without moving.

U.S. Pat. No. 5,551,879 relates to a device for enhancing lucidity in the dream state of an individual. The device includes electronic circuitry incorporated into a headband for the user to wear while sleeping. The circuitry includes a detector for fitting adjacent to the eye of the sleeping individual, for detecting Rapid Eye Movement (REM), which occurs during the dream state. The detector emits a signal that is evaluated by additional circuitry to determine whether or not REM sleep is occurring. If REM sleep is occurring, a signal is generated to operate a recorder, which typically plays prerecorded messages through the headphones engaging the ear of the sleeping individual.

U.S. Pat. No. 4,735,199 describes a dream retrieval method and system including the physiological monitoring of a sleeping subject, the analysis of recurring behavioral parameters, the application of suitable algorithms to the observed parameters and, subject stimulation in response to algorithm deductions. In one embodiment, gross body motions and postural changes are both analyzed in magnitude and regularity. Upon recognizing recurring body motions indicative of a dream cycle, the device establishes a time window during which the completion of the next dream should occur. If physiological behavior indicative of dreaming is discovered within the time window, the subject is awakened. As a result of this timely awakening, the subject obtains greater dream recall than is normally possible and may optionally record dream content.

U.S. Patent Pub. No. 20040192996 relates to an apparatus for verbal recording and storage of a dream, while U.S. Patent Pub. No. 20080114263 discloses a dream detection system that includes a mask and a control unit. The mask includes opaque eye portions and at least one sensor for detecting REM sleep. The mask may include an alarm for indicating REM sleep, a speaker, and a transmitter. The control unit includes a receiver and transmitter for receiving data from and transmitting data to the mask, respectively. The control unit includes programming for actuating an audio player to provide a predetermined cue, script, or other audible message to the mask when REM sleep is detected for alerting a sleeping person that he is dreaming and enabling the person to gain some level of control over the dream sequence. The audible message may be a morning or evening affirmation, preparation for a task, or other cues to guide a dream. The control unit may include a device with which a user may audibly record dream details.

U.S. Patent Pub. No. 2008/0073851 A1 describes an “interactive question and answer dream game”, in which a method for playing a game includes a game unit used to collect dreams in the event certain criteria are met. During the game, a dream is selected by a first player, and the first player, in response to a question from a second player provides background information. After the background information is provided, a determination is made whether the criteria are met to use the game unit as a collection point. The game players then sleep, after which additional background information is requested by the second player from the first player to determine if the criteria are met to use the game unit as a collection point for dreams.

The state of the art, therefore, is focused primarily on recording dreams for singular interpretation, research or aiding users in their ability to dream. However, none of the prior art allows or requires an individual to match elements within a dream to elements of dreams of other individuals. Furthermore, a need exists within the scientific community for a method or system that offers the ability to collect dream data with a greater sample size, which can be matched to demographic data.

### SUMMARY OF THE INVENTION

The present invention provides a method for playing a computer-based electronic game where players input recalled events from a dream and receive game awards when dream data that is input match certain, predetermined criteria.

More particularly, the present invention provides a network adapted to process written and verbal dream input via a mobile device or website for recording an individual's dreams. The network then processes the input data from one individual to match data input by other players or data otherwise entered on the database throughout the database structure. The results of this matching of the player's dream input data to the dream data on the database, including dream data input by other online players, are then returned to the player. Game awards, such as points, tokens and the like, are awarded based on the matching results.

The database is configured to categorize the dreams and individual dream data that is input based on the Hall Van De Castle Scale, or Coding System. In this system, more commonly occurring elements of dreams have been categorized; coded and assigned quantitative values based on the occurrence of the elements, and are distinguished between male and female dreamers. This quantitative system scores a dream report with 16 empirical scales, such as, for example, settings, objects, people, animals, mythological creatures, emotions, sexual content, aggression, sadness, and so on. The Hall Van de Castle system has been used in research and informal studies to measure hundreds of thousands of dreams, creating a “baseline” for normal dreaming cognition. Researchers can then contribute additional dreams from more specialized groups, such as Gulf War veterans, autistic children, or convicted murders, for example, to measure their dreams profiles against the norm.

According to one aspect of the present invention, awards are provided when the images, ideas, emotions, and sensations recalled from a dream match and input into the system via the method and game matches with images, ideas, emotions and sensation with other players on the network within a designated time period.

It is further contemplated that awards are provided when the images, ideas, emotions, and sensations recalled from a dream and input into the system match with images, ideas, emotions and sensation with other players on the network within a designated period when players share certain, even more specific characteristics. These additional characteristics can include, for example, demographic and geographic features that are shared by players.

Furthermore, it is another aspect of the present invention that awards are provided when the images, ideas, emotions, and sensations recalled from a dream and input into the system by one player match with non-dreaming events that occur after the dream has been input. In other words, awards are given to a player when an input dream appears to “predict” or “foresee” a non-dreaming waking event.
Again . . . in reading this . . . ‘news’ may be limiting. What is your thought on removing the highlighted section?

According to a further aspect of the present invention, awards are provided when the images, ideas, emotions, and sensations recalled from a dream and input into the system by a player match with images and ideas of non-dreaming events that occur after the dream has been input and which also share additional characteristics of the player, such as demographic and geographic characteristics, by way of example.

### BRIEF DESCRIPTION OF THE DRAWINGS

Embodiments of a method and game for matching elements of a player's dreams to elements on a database or input by other players according to the invention are depicted in the drawings. The invention will now be explained in greater detail with reference to these drawings.

FIG. 1 is a schemetic drawing showing a method for playing the dream-matching according to the present invention;

FIG. 2 illustrates an example of a list of data that can be generated, transmitted and displayed to the player;

FIG. 3 illustrates an example another listing of data that can be generated, transmitted and displayed to the player; and

FIG. 4 is a schematic drawing showing the interactive, dream-matching game according to the present invention.

Let's remove the word online highlighted above.

### DETAILED DESCRIPTION OF THE PREFERRED EMBODIMENTS

The present invention relates to a method for playing a computer-based, electronic, interactive online game in which a player enters the summary of a dream via an electronic device, such as a computer, a cell phone or other mobile device or onto a website.

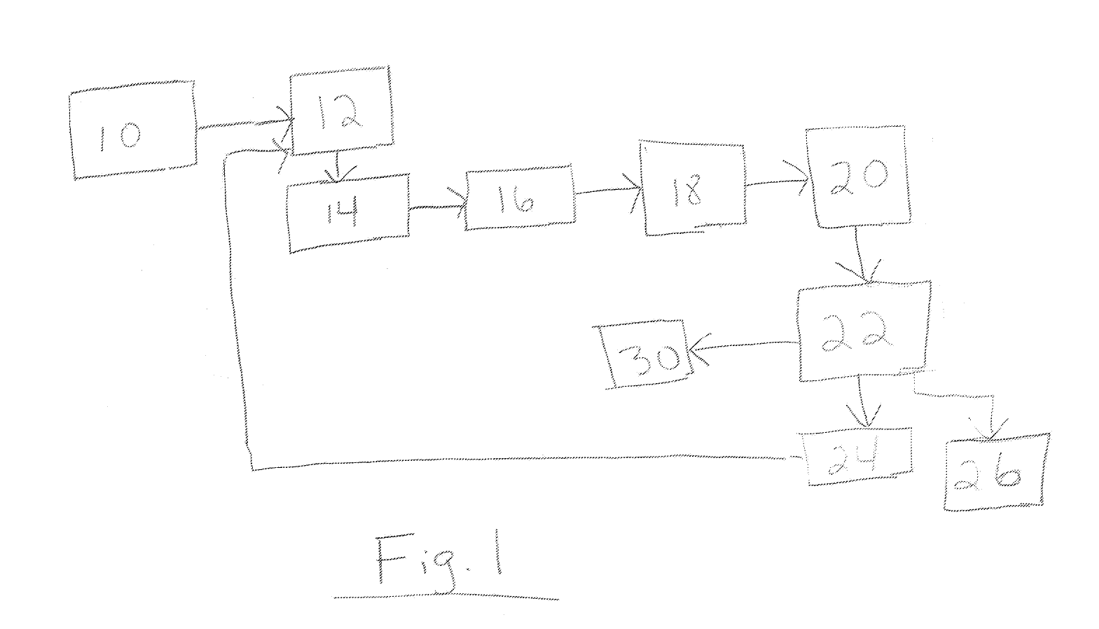

FIG. 1 illustrates in a flow diagram one embodiment of the method for playing the inventive dream-matching game. A player enters a summary of his or her dream via a computer or mobile device 10 (or on a website on the internet. The input dream data is transmitted to at least one processor 12 (i.e. computer hardware), which then accesses computer-executable instructions 14 which store the player's dream summary into a data storage device 16. The dream summary of the player input into the system is then analyzed by the processor 18 by using a dream coding system or scale stored in the data storage device, such as the Hall Van de Castle Scale described above. In a further step 20, features of the player's dream recognized by the dream coding system are then compared to features recognized by the dream coding system from dream summaries of other players who have also submitted their dream summaries into the system and/or are compared to selected criteria or features stored in the database.

The player's dream summary and features recognized by the coding scale are also compared to other data stored in the system. In a further processing step 22, the processor generates a list of matching data based on comparing selected features of said content data. The list of data comprises predetermined features that are common to content data of the player and at least one other player, which are common to the data stored in said data storage, or both. The list of matched data is then transmitted back by the processor to the electronic device of the participating players (step 24). After the data of the players' dreams has been analyzed and matched, awards, such as points or tokens, are given to the player based on the number of matches to features of other players' dreams.

As a further step 26, the dream data initially entered by the player can be compared to actual events that occur after the player has entered the dream summary. A player is then awarded additional points or awards if his dreams match actual events that occur, that is, if the dream appears to “predict” or “foresee” actual events.

The step of comparing and analyzing features of the players' respective dreams to one another or to the data stored in the database 20 further comprising analyzing and comparing by the processor of a dream summaries of the players for common demographic and geographic features.

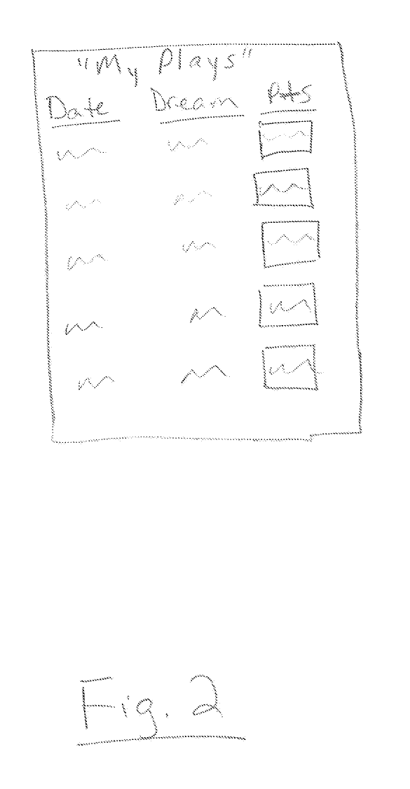

In a further step 30, a personalized play list 32 (shown in FIG. 2) preferably can be generated on request for each player, and then transmitted 32 to player's electronic device. The personalized play list 32 may include each dream summary entered by a respective player, the date when each of the dream summary was input, and a point value assigned to each dream summary.

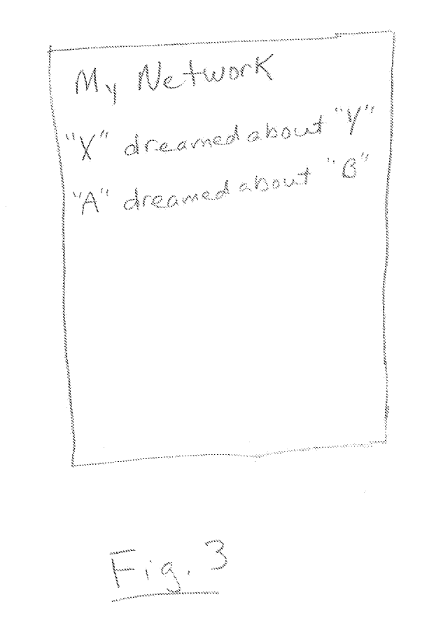

A player can further request to become part of a network of players, based on selected criteria, such as location, colleges or schools attended, age, sex, and so on. In a further step, then, 34, the processor can generate and transmit to a respective player a listing or summary page what displays information relating to all of the players with the selected network and having the designated criteria. Again, the summary page can include geographic and demographic information and particular features of the other players' dreams. FIG. 3 illustrates one example of a display of a listing or summary page for a player's network.

The processor further can be adapted to compare all of the data content that is input by all participating players, for example within a selected demographic or geographic network, and generate a “top ten list”, showing to the player which features occur most often (such as colleges, city, gender, etc.).

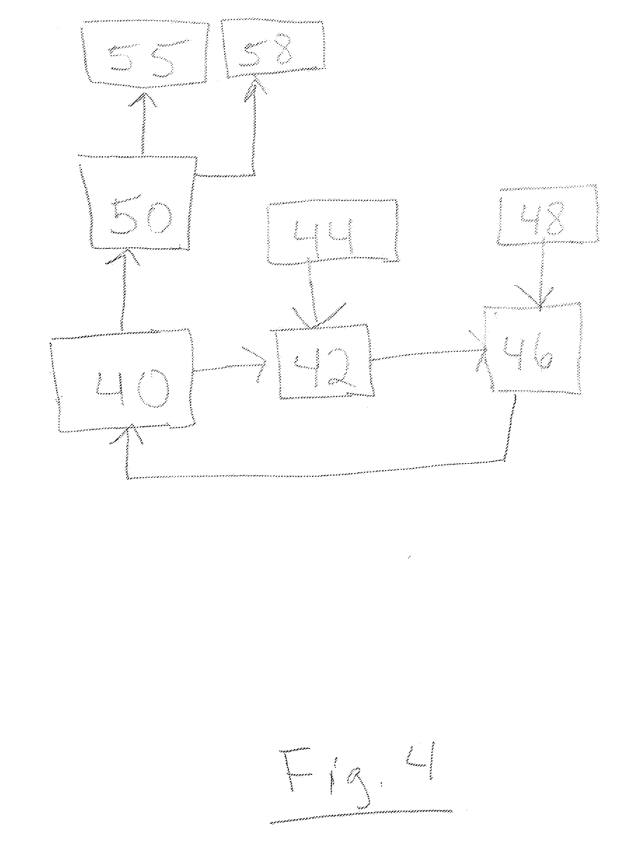

While the invention has been described above as a method for playing the inventive game, the present invention further relates to the interactive, electronic game itself. Referring now to FIG. 4, the game includes at least one computer processor 40 configured to execute modules, which include a first module 42, in turn configured to receive content data 44 input by at least one player. The content data is a summary of a dream of the player. A computer readable storage 46 is configured to store the content data 44 and to store selected, predetermined data 48. The processor 40 is configured to compare content data of the player to content data input by at least one further player, to compare the player's data to selected data 44 stored in the data storage 46, or both.

The processor 40 is configured further to generate a list of matching data 50 based on comparing the content data of the players. The list of data 50 can include predetermined features that are common to content data 44 of the player by the at least one player and at least one further player, that are common to the data stored in the data storage, or both.

The processor 40 is further configured to transmit the list of matching 50 data to cause the data to be displayed on an electronic device 55 of the at least one player, the at least one further player or both; to award point values based on successful matches made between the selected features of the at least one player's dream summary and features of the at least one further player's dream summary, features stored in said data storage, or both; and to generate, transmit and display an electronic award 58 to the players based on the point values.

It will be understood that each of the elements described above, or two or more together, may also find a useful application in other types of constructions differing from the types described above.

While the invention has been illustrated and described as embodied in a method and interactive game for matching elements of a dream with elements of dreams of others, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A computer based method for playing an interactive, online game, comprising:
inputting by at least one player of content data on an electronic device, the content data comprising a summary of a dream of said at least one player;
providing at least one processor;
accessing by said at least one processor of computer-executable instructions from at least one non-transitory computer-readable storage medium;
executing the computer-executable instructions, thereby causing computer hardware comprising the at least one processor to perform operations comprising:
storing the content data in a data storage;
comparing said content data of said at least one player to content data input by at least one further player, to selected data stored in said data storage, or both;
generating a list of matching data based on comparing selected features of said content data, wherein said list of data comprises predetermined features that are common to content data of said at least one player and said at least one further player, that are common to said data stored in said data storage, or both;
transmitting the list of matching data to cause the data to be displayed on an electronic device of said at least one player, said at least one further player or both;
awarding point values based on successful matches made between the selected features of said at least one player's dream summary and features of said at least one further player's dream summary, features stored in said data storage, or both; and
generating and displaying an electronic award to said players

2. The computer based method of claim 1, wherein said selected data stored in said data storage comprises selected information relating to actual events that occurred after input of said data content.

3. The computer based method of claim 1, further comprising processing the summary of the dream input by said at least one player to determine elements of the dream corresponding to a predetermined dream-coding scale stored in said data storage.

4. The computer based method of claim 3, wherein the dream-coding scale is the Hal Van de Castle Scale.

5. The computer based method of claim 1, further comprising analyzing and comparing by said processor of said dream summary of said at least one player and said at least one further player for common demographic and geographic features.

6. The computer based method of claim 1, further comprising generating a personalized play list for each player and transmitting said personalized play list to a mobile device of each player, wherein said personalized play list includes each dream summary entered by a respective player, the date when each of said dream summary was input, and a point value assigned to each dream summary.

7. The computer based method of claim 1, further comprising generating a network of players for at least one player based on selected parameters and transmitting to said at least one player a summary page displaying information relating to players within said network.

8. The computer based method of claim 7, wherein said selected parameters include geographic and demographic information related to each of said players.

9. The computer based method of claim 7, wherein said summary page includes information about dream content of other players within the network of the at least one player.

10. The computer based method of claim 1, further comprising comparing said data content input by each player to data content input by at least one other player and generating data list including a selected number of demographic and/or geographic features most common to said players.

11. An interactive computer game system for playing an online game, comprising:
at least one computer processor configured to execute modules comprising at least:
a first module configured to receive content data input by at least one player via an electronic device, the content data representing a summary of a dream of said at least one player;
a computer readable storage configured to store the content data and to store selected, predetermined data;
said processor configured to compare said content data of said at least one player to content data input by at least one further player, to selected data stored in said data storage, or both;
said processor further configured to generate a list of matching data based on comparing said content data, wherein said list of data comprises predetermined features that are common to content data of said at least one player and said at least one further player, that are common to said data stored in said data storage, or both;
said processor further configured to transmit the list of matching data to cause the data to be displayed on an electronic device of said at least one player, said at least one further player or both; to award point values based on successful matches made between the selected features of said at least one player's dream summary and features of said at least one further player's dream summary, features stored in said data storage, or both; and to generate, transmit and display an electronic award to said players based on said point values.

12. The computer game system of claim 11, wherein said selected data stored in said data storage comprises selected information relating to actual events occurring after input of said content data.

13. The computer game system of claim 11, wherein said process if further configured to process the summary of the dream input by said at least one player to determine elements of the dream corresponding to a predetermined dream-coding scale stored in said data storage.

14. The computer game system of claim 13, wherein the dream-coding scale is the Hall Van de Castle Scale.

15. The computer game system of claim 11, wherein said processor is further configured to analyze and compare said dream summary of said at least one player and said at least one further player for common demographic and geographic features.

16. The computer game system of claim 11, wherein said processor is further configured to generate a personalized play list for each player and transmit said personalized play list to a mobile device of each player, wherein said personalized play list includes each dream summary entered by a respective player, the date when each of said dream summary was input, and a point value assigned to each dream summary.

17. The computer game system of claim 11, wherein said processor is further configured to generate a network of players for at least one player based on selected parameters and transmitting to said at least one player a summary page displaying information relating to players within said network.

18. The computer game system of claim 17, wherein said selected parameters include geographic and demographic information relating to each of said players.

19. The computer game system of claim 17, wherein said summary page includes information about dream content of other players within the network of the at least one player.

20. The computer game system of claim 11, further comprising comparing said data content input by each player to data content input by at least one other player and generating data list including a selected number of demographic and/or geographic features most common to said players.
